(19) United States
(12) Patent Application Publication
(10) Pub. No.: US 2015/0317607 A1
(43) Pub. Date: Nov. 5, 2015

(54) System and Method for Matching Job Candidates to Job Opportunities

(71) Applicant: Groove Technologies, Inc., Philadelphia, PA (US)

(72) Inventors: Enrico Petrillo, Philadelphia, PA (US); Michael Fritz, Philadelphia, PA (US)

(73) Assignee: Groove Technologies, Inc., Philadelphia, PA (US)

(21) Appl. No.: 14/269,915

(22) Filed: May 5, 2014

(51) Int. Cl. G06Q 10/10; G06F 3/0484; G06F 3/0485; G06F 3/0482

(52) U.S. Cl. CPC G06Q 10/1053; G06F 3/0482; G06F 3/04842; G06F 3/04855

(57) ABSTRACT

The disclosure relates to a system and method for matching a job candidate to a job opportunity. The method and system includes prompting preference-selections of one or more GUI widgets that indicate preferences for a set of job attributes. The prompting displays the GUI widgets as part of a presented job opportunity. The method and system includes prompting, via the graphical user interface, one or more priority inputs corresponding to the set of job attributes. The method and system includes causing to receive a list of one or more matched job-postings in which each of the matched job-postings has an associated score value and in which the list and associated score values have been determined at least in part using a portion of the preference selections and a portion of the one or more priority inputs.

### FIELD OF THE INVENTION

The present invention is directed generally to methods and systems for a relationship management system. More particularly, in certain embodiments, the invention relates to systems and methods for matching a job candidate to a job opportunity.

### BACKGROUND OF THE INVENTION

Many tools and resources exist to assist candidates in finding a job. A company's website, for example, may publish available job opportunities and current openings. The Website may provide searching or filtering functions to allow candidates to identity job openings using one or more criteria provided by the candidate. Similarly, third-party Websites may offer such types of searching and filtering capabilities, though typically for a larger repository of job opportunities that have been aggregated by the Website operators.

However, such searching and filtering tools are static and are typically performed by the candidate only when a candidate is actively seeking a job. Though alerts may exist, they are often limited to a narrow set of search criteria. More importantly, searches may be useful when a candidate have some ideas of what they are looking to find. However, it is typical that many candidates don't know what they are looking for, though they would know if they are interested in a job-opportunity when they see it.

Recruiting services may assist a candidate in navigating through the job searching or career development process—but are often expensive and the quality of service may vary greatly among different recruiters.

There is a need for a system that assists candidates in finding their ideal job opportunity.

### SUMMARY OF THE INVENTION

Methods and systems are presented herein for a career concierge system. The career concierge system matches candidates to career opportunities in a discrete, personalized, and convenient manner. In some embodiments, the concierge system beneficially provides a personalized list of job openings and opportunities for a given candidate using preferences of job attributes and priorities of such attributes received from the candidate. The career concierge system preferably minimizes the complexity of determining a given candidate preference toward a given company, a particular industry, or a particular location or region of the country.

The career concierge system may continually search for job opportunities that matches a given candidate preferences and present such opportunities to the candidate on an on-going basis, such as through a news feed of job-opportunities.

In one aspect, the present invention provides a method of matching a job candidate to a job opportunity. The method includes prompting, by a processor, via a graphical user interface (GUI) of a computing device, preference-selections (from an end-user) of one or more GUI widgets that indicate preferences for a set of job attributes. The preferences may include one or more preferred attributes selected from a list including a preferred company, a preferred job function, a preferred department, a preferred industry, a preferred location, and a preferred salary.

The prompting (for the preference-selections) may display the GUI widgets as part of a presented job opportunity. A portion of the one or more GUI widgets may be received as a Boolean input. A portion of the one or more GUI widgets may be presented as a “like” or “dislike” indicator. In some embodiment, the presented job opportunity may correspond to a posted job opportunity (e.g., wherein the job opportunity was posted on social network sites (e.g., Facebook), Newspaper, company websites, recruiter post, job blogs, etc.). In other embodiments, the presented job opportunity may include a hypothetical job-attribute selected from a library of representative job-attributes (e.g., wherein the representative job-attributes include data selected from a list of company names, a list of job functions, a list of company departments, a list of industries, a list of locations, and a list of salary ranges).

In some implementations, the method may include prompting, by the processor, via the graphical user interface, one or more priority inputs (from the end-user) corresponding to the set of job attributes. Each of the one or more priority inputs may be received via a slider (e.g., linear bar, dial, check boxes, or any other multi-input widget) displayed via the graphical user interface.

In some implementations, the method may include causing, by the processor, to receive a list of one or more matched job-postings where each of the matched job-postings has an associated score value and where the list of the matched job-postings and the associated score values has been determined at least in part using a portion of the preference-selections and a portion of the one or more priority inputs. The list of matched job-postings may be displayed and organized based on a given score value associated to each of the list of the one or more matched job-postings.

In some implementations, the method may include displaying, by the processor, via the graphical user interface, at least a portion of the list of the one or more matched job-postings and the associated score values. The associated score values may be calculated based on an average of a given priority input (e.g., wherein each of the priority input has a range of 0 to 100) scaled by a matched result (e.g., wherein each of the matched result is determined by a Boolean comparison) of each of the preference-selections.

In certain embodiments, the method further comprises prompting, by the processor, via the graphical user interface of the computing device, rating-selections (from the end-user) corresponding with a current job (of the end-user) and/or a desired time to leave the current job.

In one aspect, the present disclosure describes a non-transitory computer readable medium for matching a job candidate to a job opportunity. The computer readable medium has instructions stored thereon, where the instructions, when executed by a processor, cause the processor to prompt, via a graphical user interface (GUI) of a computing device, preference-selections (from an end-user) of one or more GUI widgets that indicate preferences for a set of job attributes. The preferences may include one or more preferred attributes selected from a list including a preferred company, a preferred job function, a preferred department, a preferred industry, a preferred location, and a preferred salary.

The prompting (for the preference-selections) may display the GUI widgets as part of a presented job opportunity. A portion of the one or more GUI widgets may be received as a Boolean input. A portion of the one or more GUI widgets may be presented as a “like” or “dislike” indicator. In some embodiment, the presented job opportunity may correspond to a posted job opportunity (e.g., wherein the job opportunity was posted on social network sites (e.g., Facebook), Newspaper, company websites, recruiter post, job blogs, etc.). In other embodiments, the presented job opportunity may include a hypothetical job-attribute selected from a library of representative job-attributes (e.g., wherein the representative job-attributes include data selected from a list of company names, a list of job functions, a list of company departments, a list of industries, a list of locations, and a list of salary ranges).

The instructions, when executed, further cause the processor to prompt, via the graphical user interface, one or more priority inputs (from the end-user) corresponding to the set of job attributes. Each of the one or more priority inputs may be received via a slider (e.g., linear bar, dial, check boxes, or any other multi-input widget) displayed via the graphical user interface.

The instructions, when executed, further cause the processor to receive a list of one or more matched job-postings where each of the matched job-postings has an associated score value where the list of the matched job-postings and the associated score values has been determined at least in part using a portion of the preference-selections and a portion of the one or more priority inputs. The list of matched job-postings may be displayed and organized based on a given score value associated to each of the list of the one or more matched job-postings.

The instructions, when executed, further cause the processor to display, via the graphical user interface, at least a portion of the list of the one or more matched job-postings and the associated score values. The associated score values may be calculated based on an average of a given priority input (e.g., wherein each of the priority input has a range of 0 to 100) scaled by a matched result (e.g., wherein each of the matched result is determined by a Boolean comparison) of each of the preference-selections.

The instructions, when executed, further cause the processor to prompt, via the graphical user interface of the computing device, rating-selections (from the end-user) corresponding with a current job (of the end-user) and/or a desired time to leave the current job.

In one aspect, the present disclosure describes a system for matching a job candidate to a job opportunity. The system includes a processor and a memory, the memory storing instruction that, when executed by the processor, cause the processor to prompt, via a graphical user interface (GUI) of a computing device, preference-selections (from an end-user) of one or more GUI widgets that indicate preferences for a set of job attributes. The preferences may include one or more preferred attributes selected from a list including a preferred company, a preferred job function, a preferred department, a preferred industry, a preferred location, and a preferred salary.

The prompting (for the preference-selections) may display the GUI widgets as part of a presented job opportunity. A portion of the one or more GUI widgets may be received as a Boolean input. A portion of the one or more GUI widgets may be presented as a “like” or “dislike” indicator. In some embodiment, the presented job opportunity may correspond to a posted job opportunity (e.g., wherein the job opportunity was posted on social network sites (e.g., Facebook), Newspaper, company websites, recruiter post, job blogs, etc.). In other embodiments, the presented job opportunity may include a hypothetical job-attribute selected from a library of representative job-attributes (e.g., wherein the representative job-attributes include data selected from a list of company names, a list of job functions, a list of company departments, a list of industries, a list of locations, and a list of salary ranges).

The instructions, when executed, further cause the processor to prompt, via the graphical user interface, one or more priority inputs (from the end-user) corresponding to the set of job attributes. Each of the one or more priority inputs may be received via a slider (e.g., linear bar, dial, check boxes, or any other multi-input widget) displayed via the graphical user interface.

The instructions, when executed, further cause the processor to receive a list of one or more matched job-postings where each of the matched job-postings has an associated score value and where the list of the matched job-postings and the associated score values has been determined at least in part using a portion of the preference-selections and a portion of the one or more priority inputs. The list of matched job-postings may be displayed and organized based on a given score value associated to each of the list of the one or more matched job-postings.

The instructions, when executed, further cause the processor to display, via the graphical user interface, at least a portion of the list of the one or more matched job-postings and the associated score values. The associated score values may be calculated based on an average of a given priority input (e.g., wherein each of the priority input has a range of 0 to 100) scaled by a matched result (e.g., wherein each of the matched result is determined by a Boolean comparison) of each of the preference-selections.

The instructions, when executed, further cause the processor to prompt, via the graphical user interface of the computing device, rating-selections (from the end-user) corresponding with a current job (of the end-user) and/or a desired time to leave the current job.

### BRIEF DESCRIPTION OF THE DRAWINGS

FIG. 1 is a block diagram of a career concierge system in accordance with an embodiment of the invention.

FIG. 2 illustrates an example GUI for prompting preference-selections of one or more GUI widgets that indicate preferences for a set of job attributes in accordance with an illustrative embodiment of the invention.

FIG. 3 illustrates an example GUI for prompting one or more priority inputs corresponding to a set of job attributes in accordance with an illustrative embodiment of the invention.

FIG. 4 illustrates an example GUI for prompting rating-selections corresponding with a current job and/or a desired time to leave the current job in accordance with an illustrative embodiment of the invention.

FIG. 5 illustrates an example notification of a matched job opportunity in accordance with an illustrative embodiment of the invention.

FIG. 6 illustrates an example cluster-notification of a matched job opportunity in accordance with another illustrative embodiment of the invention.

FIG. 7 is a flowchart of a method for matching a candidate with an opportunity in accordance with an illustrative embodiment of the invention.

FIG. 8 is a block diagram of an example network environment for use in the methods and systems in accordance with an illustrative embodiment.

FIG. 9 is a block diagram of an example computing device and an example mobile computing device, for use in illustrative embodiments of the invention.

### DETAILED DESCRIPTION

It is contemplated that systems, devices, methods, and processes of the claimed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

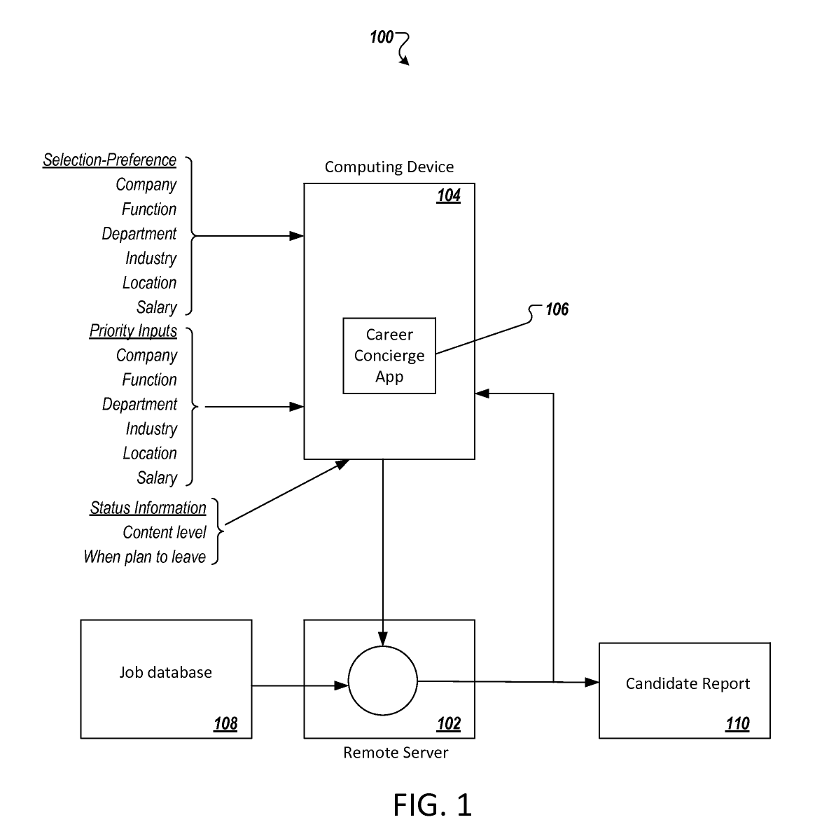

FIG. 1 is a block diagram of a career concierge system 100 in accordance with an embodiment of the invention. The career concierge system 100 includes a computing device 104 that is executing an application 106 to provide a graphical user interface and to prompt for preference and priority information about job-opportunities and job-attributes from a candidate/end-user.

The application 106 interfaces with a remote server 102 that uses the preference and priority prompted information to identify job opportunities that meet the candidates preferences. The remote server 102 preferably interfaces with a database 108 that stores job postings. In some implementations, the remote server 102 compares the prompted preference and priority information with the job postings to identify job-opportunities that matches such preferences. The identified job-opportunities may be ranked according to a score value determined for each job-opportunity. The remote server 102 may transmit the identified job-opportunities to the application 106. The remote server 102 may also send such job-opportunities as alerts or electronic correspondences and/or messages to the candidate.

In some implementations, the identified job-opportunities, score information, and prompted preferences and priority information may be aggregated in a candidate report 110 that is made available to recruiters.

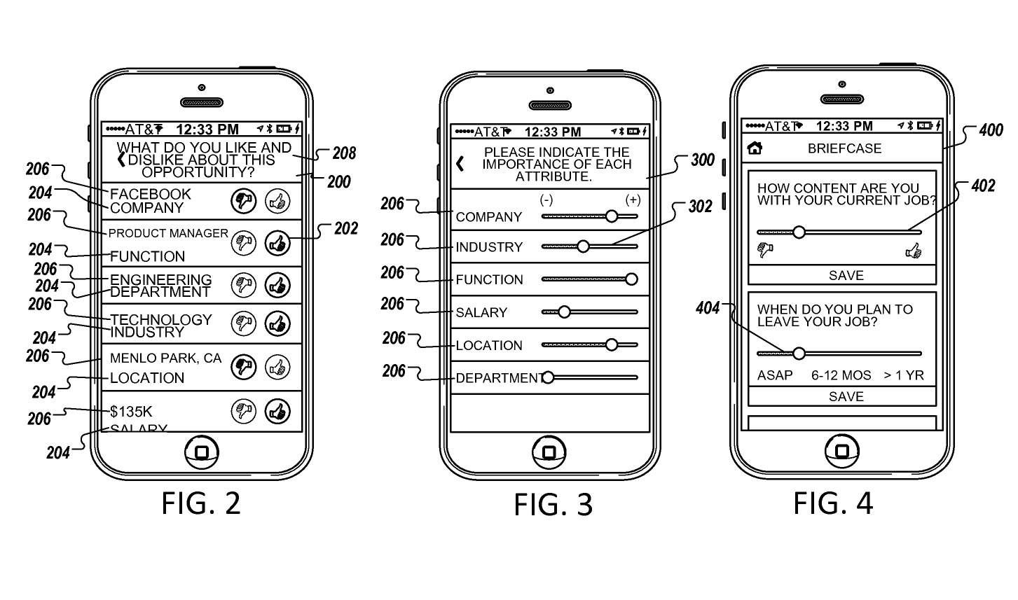

FIG. 2 illustrates an example GUI 200 for prompting preference-selections 206 (from an end-user/candidate) of one or more GUI widgets 202 that indicate preferences for a set of job attributes 204 in accordance with an illustrative embodiment of the invention. The GUI 200 displays one or more preference-selections 206 corresponding to a job attribute 204.

To reduce the complexity of the job search, the GUI 200 preferably displays the preference with corresponding widgets 202 configured as a Boolean input, such as a “like” or “dislike” button. A candidate may know of a job that they like when they see it, but may not know when asked in an open-ended manner. To this end, the GUI 200 beneficially minimizes the complexity of determining a given candidate's preferences toward a given company, a particular industry, or a particular location or region of the country. In addition, the GUI 200 receives preferences relating to the job title, position type, position level, or the job function, or the company department that the candidate is interested or disinterested in without overloading the candidate with information.

In some implementations, the widgets 202 may have a third state indicating no preference. To this end, a candidate may select a given widget 202 to connote a selection and select the same widget to un-select the selection.

The job attribute 204 may be a characteristic of a job opportunity, such as the name of the company, the job function, the department of the company, the industry to which the company belongs, the location, and the salary of the job opportunity. Each preference-selections 206 may be an instance of the attribute. For example, the preference-selections for the company attribute may be a company name (such as Facebook, Google, IBM, General Electric, Goldman Sachs, etc.) The preference-selections for the job function may be the job title or a job position. The location may be a city, region, state, or other geographic description of a job (for example, finance district, downtown, etc.)

The GUI 202 may display the preference-selections as a job opportunity. The preference-selection may include an instruction 208 to designate or cue such job opportunity as a prompt for information from the candidate.

The job opportunity may be a real opportunity that, for example, has been sourced from an existing opening at a company's Website or an on-line job posted by the career concierge system 100. The job opportunity may be an archived opportunity that has been stored by the concierge system 100. The job opportunity may be a hypothetical opportunity that has been created using aggregated information from a model of various job opportunities. The job opportunity may be an advertised job opportunity being marketed by a third party through the career concierge system 100. In some implementations, the job opportunity may be a combination of existing, archived, advertised, and hypothetical opportunities. The career concierge system 100 can use any of such opportunities to gather selection-preferences.

To this end, the career concierge system 100 may prompt preference-selections by the candidate more than once. In some implementations, the career concierge system 100 may prompt the candidate for preference-selections with a pre-defined number of job opportunities (existing, archived, or hypothetical) when the candidate first installs and initializes the application 106. The career concierge system 100 may subsequently prompt the candidate for preference-selections on each occasion that the candidate accesses the career concierge system 100.

In some implementations, the career concierge system 100 may maintain a list of preferences to elicit a representative set of preferences from a given candidate.

In other embodiments, the job opportunity may be randomly selected from a group of existing, archived, or hypothetical job opportunities.

Once collected, the career concierge system 100 may maintain a profile of preferences for a given candidate. The profile may include each of the instances of preferences that the candidate has been presented with, including preferences that the candidate has selected or not selected. The profile may further include combinations of preferences that the candidate have selected for a given set of presented job opportunity.

The profile may be associated with other personal information that the candidate may provide to the career concierge system 100. In some implementations, the career concierge system 100 collects, from the candidate, information relating to work experience, companies that the candidate may have worked, educational background, schools attended, classes that the candidate have taken, academics performance information, current or past salary, current or past job functions, hometown information, etc. In some implementations, the career concierge system 100 may source such information from third party sources, such as social media Website (such as Facebook) or on-line account (such as LinkedIn).

In some implementations, the profile may be analyzed or matched to a repository of job listings to be presented to the candidate. For example, the career concierge system 100 may employ the candidate's profile to select the job opportunities from a set of opportunities stored in a repository to present to the candidate.

The career concierge system 100 may maintain a list of related attributes to display as job-opportunities to the candidate. For example, a selection indicating a preference for a computer programming position may result in other programming positions being presented. As another example, a selection of preferences in finance may result in tangential job function, such as financial consulting, management consulting, program manager, product manager, and/or other business-related function, may be presented.

In yet another implementation, the preferences may be accumulated from one or more preference-selections to ascertain aspects of a job listing that may be important (or unimportant) to the candidate, such as the company, salary, location, function, industry, department, or other job listing aspect. Machine learning, pattern recognition, or clustering algorithms may be employed to determine one or more patterns in the candidate's preferences.

In alternative embodiments, preference-selections may be presented using a scale to represent a degree of preferences. For example, the GUI 200 may prompt the end-user to select a value ranging from extreme-like to like to neutral to dislike to extreme dislike. In another embodiment, the scale may range from extreme like to neutral to not interested.

In addition to prompting the candidate for preferences for a set of job attributes, the career concierge system 100 may further prompt the candidate for priority inputs corresponding to the set of job attributes. The priority information may be employed by the career concierge system 100 to determine the importance of such preferences in the selection of a job opportunity.

FIG. 3 illustrates an example GUI 300 for prompting one or more priority inputs 302 corresponding to a set of job attributes 304 in accordance with an illustrative embodiment of the invention.

In some implementations, the GUI 300 displays attributes 206 corresponding to those presented by GUI 200. The priority inputs 302 may be employed as a weight or scaling factor by the career concierge system 100 to rank or score a particular job opportunity to present to the candidate. In some implementations, the scale ranges preferably between 0 and 100. In other implementations, the scale ranges between 0 and 1. Of course, other ranges may be employed.

The priority inputs 302 may be presented in the GUI 300 as a sliding scale. In some implementations, the sliding scale may display only the slide without any numerical label. To this end, the priority inputs 302 may provide a subjective input for the candidate to provide priority for the various attributes.

Of course, other types of widgets may be employed (such as a linear bar, dial, check boxes, or any other multi-input widget). In some implementations, the priority inputs 302 may vary in brightness or color. For example, the priority inputs 302 may be partitioned into tiers where a different visual property is assigned to each of the tiers.

In addition to prompting the candidate for preferences for a set of job attributes and attribute priorities, the career concierge system 100 may further prompt the candidate for specific inquiries about the job search. In an embodiment, the career concierge system 100 may prompt the candidate for information concerning timing of the search and/or the candidate's present attitude towards the candidate's current job. Other inquiry may include various aspects of the current job that the candidate likes or dislikes. For example, an inquiry may include whether the candidate is seeking more responsibility or opportunity for growth. Another inquiry may include whether the candidate is seeking a position and/or company that allows for a more balanced work-life or flexible work hours or has a culture for such values.

FIG. 4 illustrates an example GUI 400 for prompting rating-selections 402 corresponding with a current job and/or a desired time 404 to leave the current job in accordance with an illustrative embodiment of the invention.

The rating-selections 402 may be an indicator corresponding to the candidate's satisfaction with his or her current job. The rating-selections 402 may be presented in GUI 400 as a sliding scale. In some implementations, the sliding scale may display only the slide without any numerical label. To this end, the rating-selections 402 may provide a subjective input for the candidate to express his or her attitude towards the current company and/or job position.

Of course, other types of widgets may be employed (such as a linear bar, dial, check boxes, or any other multi-input widget).

The desired time 404 may be an indicator corresponding to the timing of when the candidate is seeking to transition to a new job and/or career. In some implementations, the desired-time 404 may be displayed ranging from “ASAP” (“as soon as possible”) to “6-12 months” to “more than one year.” In some implementations, the career concierge system 100 may use the desired time 404 information to determine whether to present a matched job opportunity to a candidate. In other implementations, the desired time 404 information may be employed as part of the matching process.

Referring back to FIG. 1, the computing device 104 executing the career concierge application 106 may interface with a remote server 102. The computing device 104, after prompting a given candidate for preference-selections 202, priority inputs 302, and rating-selections 402, may transmit such information to the server 102. The server 102 may employ such information or portions thereof to compare to a repository 108 of job opportunities. In some implementations, the server 102 may use the preference-selections 202 to determine whether a given attribute has any weight when scoring or ranking the various job opportunities. For example, a “like' or “thumb up” or a positive preference may be represented with a value of “1”. A “dislike”, “thumb down”, or negative preference may be presented with a value of “0”. In some implementations, the negative preference may be represented with a value of “−1”.

The server 102 may use the priority inputs 302 to scale the weight of the match. The aggregation of all of the matched and weighted attributes may result in the score for a given job opportunity. The server 102 may rank the matched job opportunity using the score to present the highest matching score to the candidate. In some implementations, the server 102 may use the rating-selections 402 and/or desired timing 404 information to weigh a given job opportunity.

In some implementations, the server 102 may transmit the best matched job (i.e., having the highest score) opportunity to the career concierge application 106. In some implementations, the score may be determined using the preference-selections 202 and priority inputs 302 information. In an implementation, the career concierge system 100 may score each of the attributes of the presented job opportunity. To do so, the system 100 may designate a value of “1” if an attribute is rated positively (for example, “thumbs up”), a value of “1” if the attribute is not rated (for example, no selection of “like” or “dislike”), and a value of “0” if the attribute is rated negatively (for example, “thumbs down”). The score of each attributes may be scaled or weighted according to the values of the priority inputs associated to a given attribute. The score may be determined as a geometric mean of the various attributes. For example, the score “P” may be determined using Equation 1:

P=⁶\sqrt{(F·f)·(L·l)·(S·s)·(D·d)·(C·c)·(I·i)} Equation 1

where the “F” is a value associated with a given selected attribute corresponding to a presented job-function, “f” is the priority input associated with the job-function attribute, “L” is a value associated with a given selected attribute corresponding to job location, “l” is the priority input associated with the job location, “S” is a value associated with a given selected attribute corresponding to a presented salary, “s” is the priority input associated with the salary, “D” is a value associated with a given selected attribute corresponding to a presented company department, “d” is the priority input associated with the company department, “C” is a value associated with a given selected attribute corresponding to a presented company, “c” is the priority input associated with the presented company, “I” is a value associated with a given selected attribute corresponding to a presented industry, and “i” is the priority input associated with the presented industry. In some implementations, the inventors have found that a geometric mean gives a greater discrimination of the selected preferences and priority by the candidate and thus provides a greater dynamic range in rating and ranking job opportunities.

In alternative embodiments, the priority rating P may be determined by equation 2.

P=ⁿ{square root over ( M̅·ī Equation 2

where “ M̅” is a vector (i.e., M₁, M₂, . . . Mₙ) comprising the preference-selections (such as function, location, salary, department, company, and industry), “ī” is a corresponding vector (i.e., i₁, i₂, . . . , iₙ) comprising the priority-input ratings (such as function, location, salary, department, company, and industry importance ratings), and “n” is a scalar corresponding to the length of the vector.

The career concierge system 100 may retain the values of the priority inputs or the preferences-selection. In some implementations, the GUI 300 may load the last priority-input received from the candidate when a GUI soliciting the same preference or priority input is being displayed. In some implementations, previously selected preference-selections may be loaded if the same instance of the attribute is shown in a job opportunity to the candidate. The GUI 200 may display the widget associated with the loaded preference-selection with a different appearance (such as color or shape) than other widgets of other preference-selection which have not been previously selected.

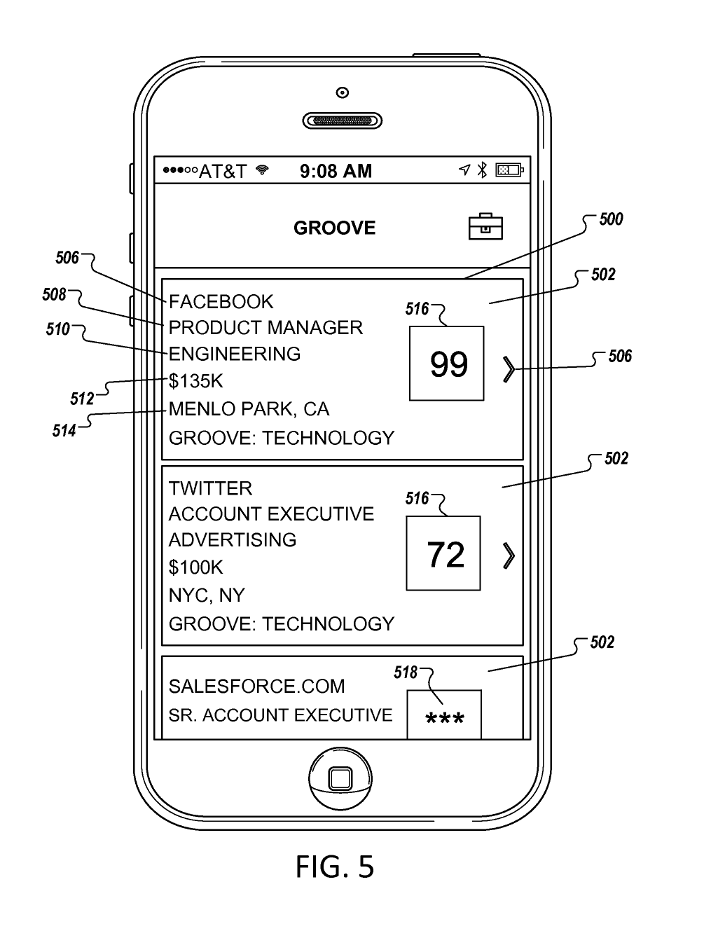

FIG. 5 illustrates an example notification 500 of a matched job opportunity 502 in accordance with an illustrative embodiment of the invention. In some implementations, the matched job opportunity 502 may be presented as a feed or a newsfeed when the candidate accesses the application 106. In some implementations, the career concierge system 100 may send matched job opportunities 502 to the candidate via electronic correspondences (such as emails or SMS messages).

The notification 500 may include one or more matched job opportunities 502. In some implementations, the notification 500 may rank and/or rate the matched job opportunities 502 in accordance with the respective score of each of the matched opportunity 502. The notification 500 may include advertised job opportunities that are interspaced with the matched job opportunities.

The notification 500 may include a selection 504 that allows a candidate to access more detailed information about a given matched job-opportunity, including contact information or a request to be contacted regarding the job opportunity. In some implementations, the GUI 500 preferably displays the matched job-opportunity with each of the attributes (such as company name 506, job function 508, company department 510, salary 512, and job/company location 514). The attributes may be employed as a summary of a given job opportunity.

In some implementations, the notification 500 may present a score value 516 associated with a given matched match opportunity.

The notification 500 may be configured in accordance with the candidate preferences. For example, the notification 500 be may presented as an electronic notification or an newsfeed update. For advertised job opportunities, the notification 500 may not present a score, and/or it may present an indicator 518 that the opportunity is being displayed as an advertisement.

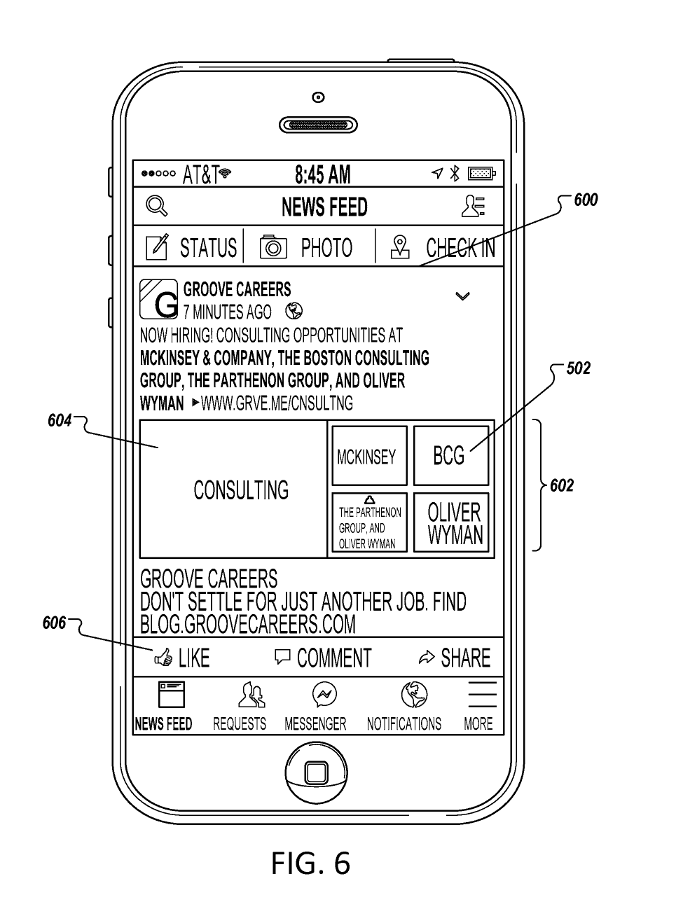

FIG. 6 illustrates an example cluster-notification 600 of a matched job opportunity 502 in accordance with another illustrative embodiment of the invention. A cluster-notification 600 includes one or more job opportunities that have been aggregated based on one or more given attributes received as a preference-selection or priority input. In some implementations, the career concierge system 100 may combine a pre-defined number of top matched job-opportunities as a cluster 602 where the top matched are grouped according to their determined score. The cluster-notification 600 may highlight the attribute 604 that is common to among the cluster 602. The notification 600 may be a part of a newsfeed.

The notification 600 may include a preference input 606 (such as a “like” button) that may provide additional preference information to the candidate's profile. For example, when the “like” button is received with respect to a given job-opportunity, the career concierge system 100 may determine the attributes associated with the job-posting and add the details to the list of preferences. For example, as shown in FIG. 6, the notification 600 illustrates several job-opportunities characterized by a job-function attribute. The notification 600 provides several companies, including McKinsey & Co., The Boston Consulting Group, the Parthenon Group, and Oliver Wyman Financial Services. If the candidate selects the preference input 606 for this posting, the career concierge system 100 may add consulting as a preferred job-function or preferred department as a selection preference as well as each of the listed companies as preferred companies. Similarly, if the geographic location for the job-opportunities is listed, the career concierge system 100 may add the listed geographic location as a preferred location.

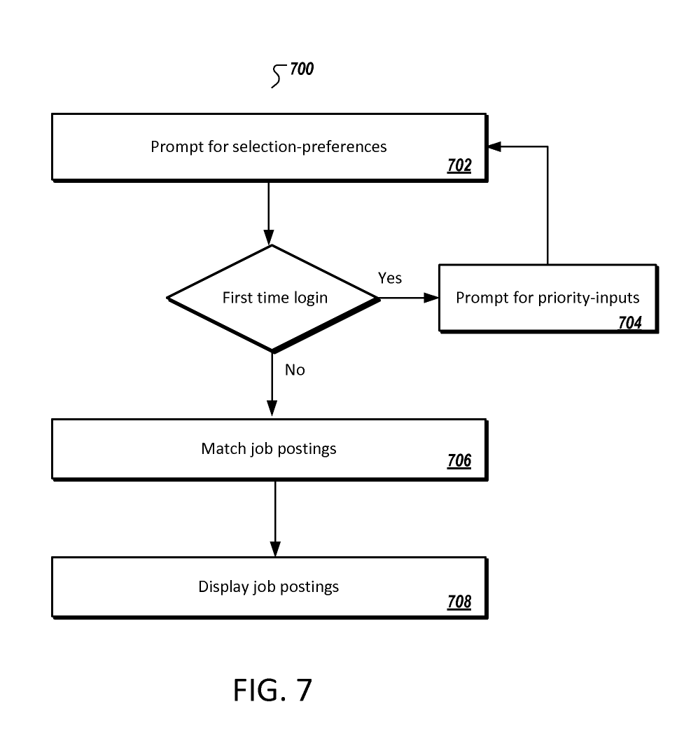

FIG. 7 is a flowchart of a method 700 for matching a candidate with an opportunity in accordance with an illustrative embodiment of the invention. The method includes prompting, by a processor, via a graphical user interface 200 of a computing device, preference-selections 206 (from an end-user) of one or more GUI widgets 202 that indicate preferences for a set of job attributes 204 (step 702). The preferences 206 may include one or more preferred attributes selected from a list including a preferred company, a preferred job function, a preferred department, a preferred industry, a preferred location, and a preferred salary.

The prompting (for the preference-selections) may display the GUI widgets 202 as part of a presented job opportunity. A portion of the one or more GUI widgets 202 may be received as a Boolean input. A portion of the one or more GUI widgets 202 may be presented as a “like” or “dislike” indicator. In some embodiment, the presented job opportunity may correspond to a posted job opportunity (e.g., wherein the job opportunity was posted on social network sites (e.g., Facebook), Newspaper, company websites, recruiter post, job blogs, etc.). In other embodiments, the presented job opportunity may include a hypothetical job-attribute selected from a library of representative job-attributes (e.g., wherein the representative job-attributes include data selected from a list of company names, a list of job functions, a list of company departments, a list of industries, a list of locations, and a list of salary ranges).

In some implementations, the method 700 may include prompting, by the processor, via the graphical user interface 300, one or more priority inputs 302 (from the end-user) corresponding to the set of job attributes 206 (step 704). Each of the one or more priority inputs 302 may be received via a slider (e.g., linear bar, dial, check boxes, or any other multi-input widget) displayed via the graphical user interface 300. The prompting may be presented to the candidate (i.e., end-user) when the application 106 is installed or when the candidate accesses the GUI 300 from a main menu.

In some implementations, the method may include causing, by the processor, to receive a list of one or more matched job-postings where each of the matched job-postings has an associated score value 516 and where the list of the matched job-postings 502 and the associated score values 516 have been determined (step 706) at least in part using a portion of the preference-selections 202 and a portion of the one or more priority inputs 302. The list of matched job-postings 502 may be displayed and organized based on a given score value 516 associated to each of the list of the one or more matched job-postings. The determination step 706 may be performed on a remote server that is separate from the computing device.

In some implementations, the method may include displaying (step 708), by the processor, via the graphical user interface (for example, 500 or 600), at least a portion of the list of the one or more matched job-postings and the associated score values. The associated score values may be calculated based on an average of a given priority input (e.g., wherein each of the priority input has a range of 0 to 100) scaled by a matched result (e.g., wherein each of the matched result is determined by a Boolean comparison) of each of the preference-selections.

In certain embodiments, the method further comprises prompting, by the processor, via the graphical user interface 400 of the computing device, rating-selections 402 (from the end-user) corresponding with a current job (of the end-user) and/or a desired time to leave the current job.

It should be understood that the order of steps or order for performing certain action is immaterial so long as the invention remains operable. Moreover, two or more steps or actions may be conducted simultaneously.

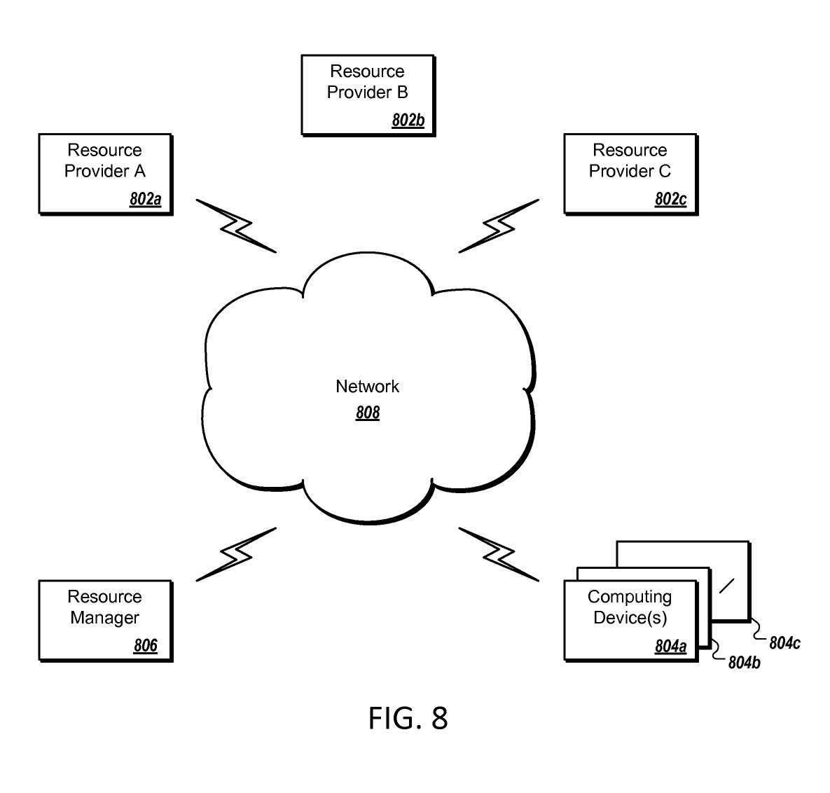

FIG. 8 shows an illustrative network environment 800 for use in the methods and systems for analysis of spectrometry data corresponding to particles of a sample, as described herein. The cloud computing environment 800 may include one or more resource providers 802a, 802b, 802c (collectively, 802). Each resource provider 802 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 802 may be connected to any other resource provider 802 in the cloud computing environment 800. In some implementations, the resource providers 802 may be connected over a computer network 808. Each resource provider 802 may be connected to one or more computing device 804a, 804b, 804c (collectively, 804), over the computer network 808.

The cloud computing environment 800 may include a resource manager 806. The resource manager 806 may be connected to the resource providers 802 and the computing devices 804 over the computer network 808. In some implementations, the resource manager 806 may facilitate the provision of computing resources by one or more resource providers 802 to one or more computing devices 804. The resource manager 806 may receive a request for a computing resource from a particular computing device 804. The resource manager 806 may identify one or more resource providers 802 capable of providing the computing resource requested by the computing device 804. The resource manager 806 may select a resource provider 802 to provide the computing resource. The resource manager 806 may facilitate a connection between the resource provider 802 and a particular computing device 804. In some implementations, the resource manager 806 may establish a connection between a particular resource provider 802 and a particular computing device 804. In some implementations, the resource manager 806 may redirect a particular computing device 804 to a particular resource provider 802 with the requested computing resource.

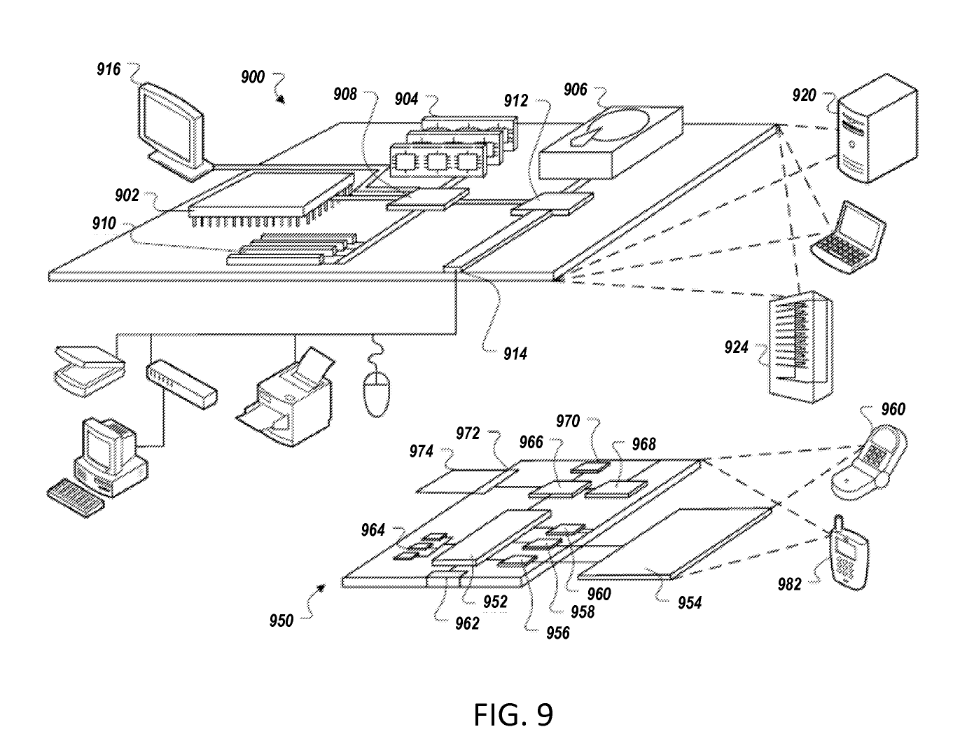

FIG. 9 shows an example of a computing device 900 and a mobile computing device 950 that can be used in the methods and systems described in this disclosure. The computing device 900 is intended to represent various forms of digital computers, such as laptops, desktops, workstations, personal digital assistants, servers, blade servers, mainframes, and other appropriate computers. The mobile computing device 950 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device 906. Each of the processor 902, the memory 904, the storage device 906, the high-speed interface 908, the high-speed expansion ports 910, and the low-speed interface 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 may also be another form of computer-readable medium, such as a magnetic or optical disk.

The storage device 906 is capable of providing mass storage for the computing device 900. In some implementations, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 902), perform one or more methods, such as those described above. The instructions can also be stored by one or more storage devices such as computer- or machine-readable mediums (for example, the memory 904, the storage device 906, or memory on the processor 902).

The high-speed interface 908 manages bandwidth-intensive operations for the computing device 900, while the low-speed interface 912 manages lower bandwidth-intensive operations. Such allocation of functions is an example only. In some implementations, the high-speed interface 908 is coupled to the memory 904, the display 916 (e.g., through a graphics processor or accelerator), and to the high-speed expansion ports 910, which may accept various expansion cards (not shown). In the implementation, the low-speed interface 912 is coupled to the storage device 906 and the low-speed expansion port 914. The low-speed expansion port 914, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. In addition, it may be implemented in a personal computer such as a laptop computer 922. It may also be implemented as part of a rack server system 924. Alternatively, components from the computing device 900 may be combined with other components in a mobile device (not shown), such as a mobile computing device 950. Each of such devices may contain one or more of the computing device 900 and the mobile computing device 950, and an entire system may be made up of multiple computing devices communicating with each other.

The mobile computing device 950 includes a processor 952, a memory 964, an input/output device such as a display 954, a communication interface 966, and a transceiver 968, among other components. The mobile computing device 950 may also be provided with a storage device, such as a micro-drive or other device, to provide additional storage. Each of the processor 952, the memory 964, the display 954, the communication interface 966, and the transceiver 968, are interconnected using various buses, and several of the components may be mounted on a common motherboard or in other manners as appropriate.

The processor 952 can execute instructions within the mobile computing device 950, including instructions stored in the memory 964. The processor 952 may be implemented as a chipset of chips that include separate and multiple analog and digital processors. The processor 952 may provide, for example, for coordination of the other components of the mobile computing device 950, such as control of user interfaces, applications run by the mobile computing device 950, and wireless communication by the mobile computing device 950.

The processor 952 may communicate with a user through a control interface 958 and a display interface 956 coupled to the display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may provide communication with the processor 952, so as to enable near area communication of the mobile computing device 950 with other devices. The external interface 962 may provide, for example, for wired communication in some implementations, or for wireless communication in other implementations, and multiple interfaces may also be used.

The memory 964 stores information within the mobile computing device 950. The memory 964 can be implemented as one or more of a computer-readable medium or media, a volatile memory unit or units, or a non-volatile memory unit or units. An expansion memory 974 may also be provided and connected to the mobile computing device 950 through an expansion interface 972, which may include, for example, a SIMM (Single In Line Memory Module) card interface. The expansion memory 974 may provide extra storage space for the mobile computing device 950, or may also store applications or other information for the mobile computing device 950. Specifically, the expansion memory 974 may include instructions to carry out or supplement the processes described above, and may include secure information also. Thus, for example, the expansion memory 974 may be provided as a security module for the mobile computing device 950, and may be programmed with instructions that permit secure use of the mobile computing device 950. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 952), perform one or more methods, such as those described above. The instructions can also be stored by one or more storage devices, such as one or more computer- or machine-readable mediums (for example, the memory 964, the expansion memory 974, or memory on the processor 952). In some implementations, the instructions can be received in a propagated signal, for example, over the transceiver 968 or the external interface 962.

The mobile computing device 950 may communicate wirelessly through the communication interface 966, which may include digital signal processing circuitry where necessary. The communication interface 966 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 968 using a radio-frequency. In addition, short-range communication may occur, such as using a Bluetooth®, Wi-Fi™, or other such transceiver (not shown). In addition, a GPS (Global Positioning System) receiver module 970 may provide additional navigation- and location-related wireless data to the mobile computing device 950, which may be used as appropriate by applications running on the mobile computing device 950.

The mobile computing device 950 may also communicate audibly using an audio codec 960, which may receive spoken information from a user and convert it to usable digital information. The audio codec 960 may likewise generate audible sound for a user, such as through a speaker, e.g., in a handset of the mobile computing device 950. Such sound may include sound from voice telephone calls, may include recorded sound (e.g., voice messages, music files, etc.) and may also include sound generated by applications operating on the mobile computing device 950.

The mobile computing device 950 may be implemented in a number of different forms, as shown in the figure. For example, it may be implemented as a cellular telephone 980. It may also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method of matching a job candidate to a job opportunity, the method comprising:
prompting, by a processor, via a graphical user interface of a computing device, preference-selections of one or more GUI widgets that indicate preferences for a set of job attributes, wherein
the prompting (for the preference-selections) displays the one or more GUI widgets as part of a presented job opportunity;
prompting, by the processor, via the graphical user interface, one or more priority inputs corresponding to the set of job attributes;
causing, by the processor, to receive a list of one or more matched job-postings, wherein
each of the one or more matched job-postings has an associated score value, and wherein
the list of the one or more matched job-postings and the associated score values has been determined at least in part using a portion of the preference-selections and a portion of the one or more priority inputs; and
displaying, by the processor, via the graphical user interface, at least a portion of the list of the one or more matched job-postings and the associated score values.

2. The method of claim 1, wherein the list of the one or more matched job-postings is displayed and organized based on a given score value associated to each of the list of the one or more matched job-postings.

3. The method of claim 1, wherein the list of the one or more matched job-postings and the associated score values has been determined using a remote server.

4. The method of claim 1, wherein a portion of the one or more GUI widgets is received as a Boolean input.

5. The method of claim 1, wherein a portion of the one or more GUI widgets is presented as a “like” or “dislike” indicator.

6. The method of claim 1, wherein each of the one or more priority inputs is received via a slider (e.g., linear bar, dial, check boxes, or any other multi-input widget) displayed via the graphical user interface.

7. The method of claim 1, wherein the presented job opportunity corresponds to a posted job opportunity (e.g., wherein the job opportunity was posted on social network sites (e.g., Facebook), Newspaper, company websites, recruiter post, job blogs, etc.).

8. The method of claim 1, wherein the presented job opportunity comprises a hypothetical job-attribute selected from a library of representative job-attributes (e.g., wherein the representative job-attributes include data selected from a list of company names, a list of job functions, a list of company departments, a list of industries, a list of locations, and a list of salary ranges).

9. The method of claim 1, wherein the associated score values are calculated based on an average of a given priority input (e.g., wherein each of the priority input has a range of 0 to 100) scaled by a matched result (e.g., wherein each of the matched result is determined by a Boolean comparison) of each of the preference-selections.

10. The method of claim 1, comprising:
prompting, by the processor, via the graphical user interface of the computing device, rating-selections (from the end-user) corresponding with a current job (of the end-user) and/or a desired time to leave the current job.

11. A non-transitory computer readable medium having instructions stored thereon, wherein the instructions, when executed by a processor, cause the processor to:
prompt, via a graphical user interface of a computing device, preference-selections (from an end-user) of one or more GUI widgets that indicate preferences for a set of job attributes (e.g., wherein the preferences comprise one or more preferred attributes selected from a list comprising of a preferred company, a preferred job function, a preferred department, a preferred industry, a preferred location, and a preferred salary), wherein
the prompting (for the preference-selections) displays the one or more GUI widgets as part of a presented job opportunity;
prompt, via the graphical user interface, one or more priority inputs (from the end-user) corresponding to the set of job attributes;
cause to receive a list of one or more matched job-postings, wherein
each of the one or more matched job-postings has an associated score value, and wherein
the list of the one or more matched job-postings and the associated score values has been determined at least in part using a portion of the preference-selections and a portion of the one or more priority inputs; and
display, via the graphical user interface, at least a portion of the list of the one or more matched job-postings and the associated score values.

12. The computer readable medium of claim 11, wherein the list of the one or more matched job-postings is displayed and organized based on a given score value associated to each of the list of the one or more matched job-postings.

13. The computer readable medium of claim 11, wherein the instructions, when executed by the processor, cause the processor to prompt, via the graphical user interface, a satisfaction rating associated with a current job (by the end-user) and/or a desired time to leave the current job.

14. The computer readable medium of claim 11, wherein a portion of the one or more GUI widgets is received as a Boolean input.

15. The computer readable medium of claim 11, wherein a portion of the one or more GUI widgets is presented as a “like” or “dislike” indicator.

16. The computer readable medium of claim 11, wherein each of the one or more priority inputs is received via a slider (e.g., linear bar, dial, check boxes, or any other multi-input widget) displayed via the graphical user interface.

17. The computer readable medium of claim 11, the presented job opportunity corresponds to a posted job opportunity (e.g., wherein the job opportunity was posted on Facebook, Newspaper, company websites, etc.).

18. The computer readable medium of claim 11, wherein the instructions, when executed by the processor, cause the processor to prompt, via the graphical user interface of the computing device, rating-selections (from the end-user) corresponding with a current job (of the end-user) and/or a desired time to leave the current job.

19. The computer readable medium of claim 11, wherein the instructions, when executed by the processor, cause the processor to prompt, via the graphical user interface of the computing device, rating-selections (from the end-user) corresponding with a current job (of the end-user) and/or a desired time to leave the current job.

20. A system for matching a job candidate to a job opportunity comprising:
a processor; and
a memory, the memory storing instructions that, when executed by the processor, cause the processor to:
prompt, via a graphical user interface of a computing device, preference-selections (from an end-user) of one or more GUI widgets that indicate preferences for a set of job attributes (e.g., wherein the preferences comprise one or more preferred attributes selected from a list comprising of a preferred company, a preferred job function, a preferred department, a preferred industry, a preferred location, and a preferred salary), wherein
the prompting (for the preference-selections) displays the one or more GUI widgets as part of a presented job opportunity;
prompt, via the graphical user interface, one or more priority inputs (from the end-user) corresponding to the set of job attributes;
cause to receive a list of one or more matched job-postings, wherein
each of the one or more matched job-postings has an associated score value, and wherein
the list of the one or more matched job-postings and the associated score values has been determined at least in part using a portion of the preference-selections and a portion of the one or more priority inputs; and
display, via the graphical user interface, at least a portion of the list of the one or more matched job-postings and the associated score values.
